(19) United States
(12) Patent Application Publication
(10) Pub. No.: US 2022/0285723 A1
(43) Pub. Date: Sep. 8, 2022

(54) Method And System For Safety Of Silicon Dominant Anodes

(71) Applicant: Enevate Corporation, Irvine, CA (US)

(72) Inventors: Benjamin Park, Mission Viejo, CA (US); Hong Zhao, Aliso Viejo, CA (US); Heidi Anderson, Huntington Beach, CA (US); Mya Le Thai, Fountain Valley, CA (US)

(21) Appl. No.: 17/193,850

(22) Filed: Mar. 5, 2021

(51) Int. Cl. H01M 10/0525; H01M 4/38; H01M 4/66; H01M 50/451; H01M 10/0562; H01M 4/62

(52) U.S. Cl. CPC H01M 10/0525; H01M 4/386; H01M 4/661; H01M 50/451; H01M 10/0562; H01M 4/625; H01M 2004/027

(57) ABSTRACT

Systems and methods provide for safety of silicon dominant anodes in a battery. The battery may include an anode comprising an anode active material layer on a metal current collector, where the anode active material layer comprises pyrolyzed binder, conductive additives, and 50% or more silicon by weight. The battery may further include a separator, an electrolyte, a cathode, and a solid electrolyte interface between the anode active material layer and the electrolyte, and has a thermal runaway temperature of greater than 260° C. The conductive additives may comprise between 1% and 40% of the active material layer. The anode active material layer may comprise between 20% to 95% silicon. The separator may comprise ceramic-coated polyolefin or polymer-coated polyolefin. The electrolyte may comprise Lithium hexafluorophosphate (LiPF₆) and/or lithium bis(trifluoromethanesulfonyl)imide (LiTFSI) in one or more electrolyte solvents. The metal current collector may comprise copper.

### REFERENCE

N/A

### FIELD

Aspects of the present disclosure relate to energy generation and storage. More specifically, certain embodiments of the disclosure relate to a method and system for safety of silicon dominant anodes.

### BACKGROUND

Conventional approaches for batteries may be costly, cumbersome, inefficient, and/or unsafe in many applications.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

A system and/or method for safety of silicon dominant anodes, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is a diagram of a battery, in accordance with an example embodiment of the disclosure.

FIG. 2A is a flow diagram of a lamination process for forming a silicon-dominant anode cell, in accordance with an example embodiment of the disclosure.

FIG. 2B is a flow diagram of a direct coating process for forming a silicon-dominant anode cell, in accordance with an example embodiment of the disclosure.

FIG. 3A illustrates accelerating rate calorimeter results for a silicon-dominant anode cell, in accordance with an example embodiment of the disclosure.

FIG. 3B illustrates another accelerating rate calorimeter result for a silicon-dominant anode cell and a graphite cell, in accordance with an example embodiment of the disclosure.

FIG. 4A illustrates nail penetration tests for a graphite cell and a silicon-dominant anode cell, in accordance with an example embodiment of the disclosure.

FIG. 4B illustrates voltage and temperature curves for a silicon-dominant anode cell and a graphite cell during a nail penetration test, in accordance with an example embodiment of the disclosure.

FIG. 5 illustrates a silicon-dominant anode lithium ion cell, in accordance with an example embodiment of the disclosure.

### DETAILED DESCRIPTION OF THE INVENTION

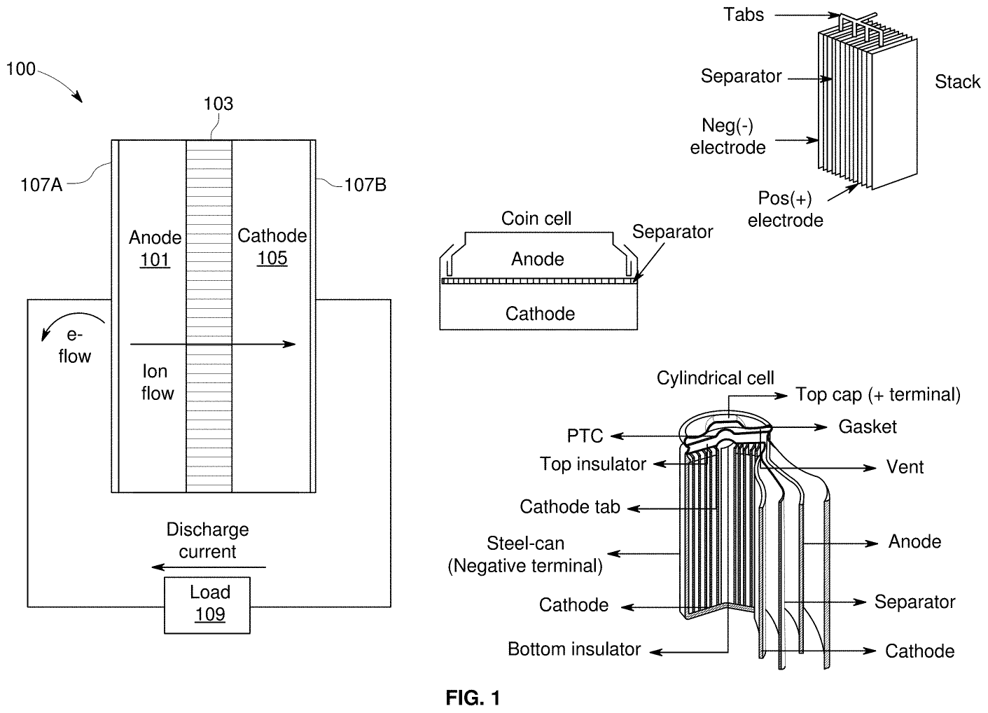

FIG. 1 is a diagram of a battery with silicon-dominant anodes, in accordance with an example embodiment of the disclosure. Referring to FIG. 1, there is shown a battery 100 comprising a separator 103 sandwiched between an anode 101 and a cathode 105, with current collectors 107A and 107B. There is also shown a load 109 coupled to the battery 100 illustrating instances when the battery 100 is in discharge mode. In this disclosure, the term “battery” may be used to indicate a single electrochemical cell, a plurality of electrochemical cells formed into a module, and/or a plurality of modules formed into a pack. Furthermore, the battery 100 shown in FIG. 1 is a very simplified example merely to show the principle of operation of a lithium ion cell. Examples of realistic structures are shown to the right in FIG. 1, where stacks of electrodes and separators are utilized, with electrode coatings typically on both sides of the current collectors. The stacks may be formed into different shapes, such as a coin cell, cylindrical cell, or prismatic cell, for example.

The development of portable electronic devices and electrification of transportation drive the need for high performance electrochemical energy storage. Small-scale (<100 Wh) to large-scale (>10 KWh) devices primarily use lithium-ion (Li-ion) batteries over other rechargeable battery chemistries due to their high-performance.

The anode 101 and cathode 105, along with the current collectors 107A and 107B, may comprise the electrodes, which may comprise plates or films within, or containing, an electrolyte material, where the plates may provide a physical barrier for containing the electrolyte as well as a conductive contact to external structures. In other embodiments, the anode/cathode plates are immersed in electrolyte while an outer casing provides electrolyte containment. The anode 101 and cathode are electrically coupled to the current collectors 107A and 1078, which comprise metal or other conductive material for providing electrical contact to the electrodes as well as physical support for the active material in forming electrodes.

The configuration shown in FIG. 1 illustrates the battery 100 in discharge mode, whereas in a charging configuration, the load 109 may be replaced with a charger to reverse the process. In one class of batteries, the separator 103 is generally a film material, made of an electrically insulating polymer, for example, that prevents electrons from flowing from anode 101 to cathode 105, or vice versa, while being porous enough to allow ions to pass through the separator 103. Typically, the separator 103, cathode 105, and anode 101 materials are individually formed into sheets, films, or active material coated foils. Sheets of the cathode, separator and anode are subsequently stacked or rolled with the separator 103 separating the cathode 105 and anode 101 to form the battery 100. In some embodiments, the separator 103 is a sheet and generally utilizes winding methods and stacking in its manufacture. In these methods, the anodes, cathodes, and current collectors (e.g., electrodes) may comprise films.

In an example scenario, the battery 100 may comprise a solid, liquid, or gel electrolyte. The separator 103 preferably does not dissolve in typical battery electrolytes such as compositions that may comprise: Ethylene Carbonate (EC), Fluoroethylene Carbonate (FEC), Propylene Carbonate (PC), Dimethyl Carbonate (DMC), Ethyl Methyl Carbonate (EMC), Diethyl Carbonate (DEC), etc. with dissolved LiBF₄, LiAsF₆, LiPF₆, and LiClO₄ etc. In an example scenario, the electrolyte may comprise Lithium hexafluorophosphate (LiPF₆) and lithium bis(trifluoromethanesulfonyl)imide (LiTFSI) that may be used together in a variety of electrolyte solvents. Lithium hexafluorophosphate (LiPF₆) may be present at a concentration of about 0.1 to 2.0 molar (M) and lithium bis(trifluoromethanesulfonyl)imide (LiTFSI) may be present at a concentration of about 0 to 2.0 molar (M). Solvents may comprise one or more of ethylene carbonate (EC), fluoroethylene carbonate (FEC) and/or ethyl methyl carbonate (EMC) in various percentages. In some embodiments, the electrolyte solvents may comprise one or more of EC from about 0-40%, FEC from about 2-40% and/or EMC from about 50-70% by weight. In another example, the electrolyte comprises 20% or more FEC. In another example, the electrolyte may comprise no cyclic carbonate other than FEC.

The separator 103 may be wet or soaked with a liquid or gel electrolyte. In addition, in an example embodiment, the separator 103 does not melt below about 100 to 120° C., and exhibits sufficient mechanical properties for battery applications. A battery, in operation, can experience expansion and contraction of the anode and/or the cathode. In an example embodiment, the separator 103 can expand and contract by at least about 5 to 10% without failing, and may also be flexible.

The separator 103 may be sufficiently porous so that ions can pass through the separator once wet with, for example, a liquid or gel electrolyte. Alternatively (or additionally), the separator may absorb the electrolyte through a gelling or other process even without significant porosity. The porosity of the separator 103 is also generally not too porous to allow the anode 101 and cathode 105 to transfer electrons through the separator 103.

The anode 101 and cathode 105 comprise electrodes for the battery 100, providing electrical connections to the device for transfer of electrical charge in charge and discharge states. The anode 101 may comprise silicon, carbon, or combinations of these materials, for example. Typical anode electrodes comprise a carbon material that includes a current collector such as a copper sheet. Carbon is often used because it has excellent electrochemical properties and is also electrically conductive. Anode electrodes currently used in rechargeable lithium-ion cells typically have a specific capacity of approximately 200 milliamp hours per gram. Graphite, the active material used in most lithium ion battery anodes, has a theoretical energy density of 372 milliamp hours per gram (mAh/g). In comparison, silicon has a high theoretical capacity of 4200 mAh/g. In order to increase volumetric and gravimetric energy density of lithium-ion batteries, silicon may be used as the active material for the cathode or anode. Silicon anodes may be formed from silicon composites, with more than 50% silicon or more by weight in the anode material on the current collector, for example.

In an example scenario, the anode 101 and cathode 105 store the ion used for separation of charge, such as lithium. In this example, the electrolyte carries positively charged lithium ions from the anode 101 to the cathode 105 in discharge mode, as shown in FIG. 1 for example, and vice versa through the separator 105 in charge mode. The movement of the lithium ions creates free electrons in the anode 101 which creates a charge at the positive current collector 1078. The electrical current then flows from the current collector through the load 109 to the negative current collector 107A. The separator 103 blocks the flow of electrons inside the battery 100, allows the flow of lithium ions, and prevents direct contact between the electrodes.

While the battery 100 is discharging and providing an electric current, the anode 101 releases lithium ions to the cathode 105 via the separator 103, generating a flow of electrons from one side to the other via the coupled load 109. When the battery is being charged, the opposite happens where lithium ions are released by the cathode 105 and received by the anode 101.

The materials selected for the anode 101 and cathode 105 are important for the reliability and energy density possible for the battery 100. The energy, power, cost, and safety of current Li-ion batteries need to be improved in order to, for example, compete with internal combustion engine (ICE) technology and allow for the widespread adoption of electric vehicles (EVs). High energy density, high power density, and improved safety of lithium-ion batteries are achieved with the development of high-capacity and high-voltage cathodes, high-capacity anodes and functionally non-flammable electrolytes with high voltage stability and interfacial compatibility with electrodes. In addition, materials with low toxicity are beneficial as battery materials to reduce process cost and promote consumer safety.

The performance of electrochemical electrodes, while dependent on many factors, is largely dependent on the robustness of electrical contact between electrode particles, as well as between the current collector and the electrode particles. The electrical conductivity of silicon anode electrodes may be manipulated by incorporating conductive additives with different morphological properties. Carbon black (SuperP), vapor grown carbon fibers (VGCF), and a mixture of the two have previously been incorporated separately into the anode electrode resulting in improved performance of the anode. The synergistic interactions between the two carbon materials may facilitate electrical contact throughout the large volume changes of the silicon anode during charge and discharge.

State-of-the-art lithium-ion batteries typically employ a graphite-dominant anode as an intercalation material for lithium. Silicon-dominant anodes, however, offer improvements compared to graphite-dominant Li-ion batteries. Silicon exhibits both higher gravimetric (4200 mAh/g vs. 372 mAh/g for graphite) and volumetric capacities (2194 mAh/L vs. 890 mAh/L for graphite). In addition, silicon-based anodes have a low lithiation/delithiation voltage plateau at about 0.1-0.7 V vs. Li/Li+, which allows it to maintain an open circuit potential that avoids undesirable Li plating and dendrite formation. While silicon shows excellent electrochemical activity, achieving a stable cycle life for silicon-based anodes is challenging due to silicon's large volume changes during lithiation and delithiation. Silicon regions may lose electrical contact from the anode as large volume changes coupled with its low electrical conductivity separate the silicon from surrounding materials in the anode.

In addition, the large silicon volume changes exacerbate solid electrolyte interphase (SEI) formation, which can further lead to electrical isolation and, thus, capacity loss. Expansion and shrinkage of silicon particles upon charge-discharge cycling causes pulverization of silicon particles, which increases their specific surface area. As the silicon surface area changes and increases during cycling, SEI repeatedly breaks apart and reforms. The SEI thus continually builds up around the pulverizing silicon regions during cycling into a thick electronic and ionic insulating layer. This accumulating SEI increases the impedance of the electrode and reduces the electrode electrochemical reactivity, which is detrimental to cycle life.

However, the SEI in silicon-dominant anodes or certain silicon-dominant anodes with binder derived from pyrolyzed polymer has a safety advantage in comparison to graphite cells, even those with silicon additives. The SEI layer may provide protection against adverse chemical reactions with the electrolyte that can lead to thermal runaway. SEI dissolution or other SEI exothermic reactions are often one of the earliest exothermic reactions to occur in a cell if the temperature is increased and this reaction acts as the “trigger” for thermal runaway. Similarly, the SEI layer and the anode active material layer in the silicon-dominant cells disclosed here may have improved thermal conductivity, reducing the likelihood of thermal runaway by reducing local temperature (e.g. near the nail in a nail penetration test) by spreading the heat efficiently to the rest of the cell. The silicon-dominant anodes described here have significantly higher thermal runaway temperatures. Furthermore, the electrolytes used with silicon-dominant anodes that are described here also may be less susceptible to thermal runaway. In addition, these silicon-dominant anode cells pass the nail penetration test, in which a nail is forced through the cell, shorting it out. This test normally results in explosive and fiery failure of graphite and silicon-additive graphite cells.

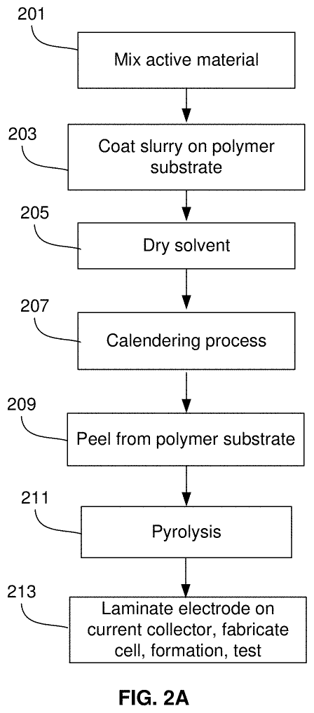

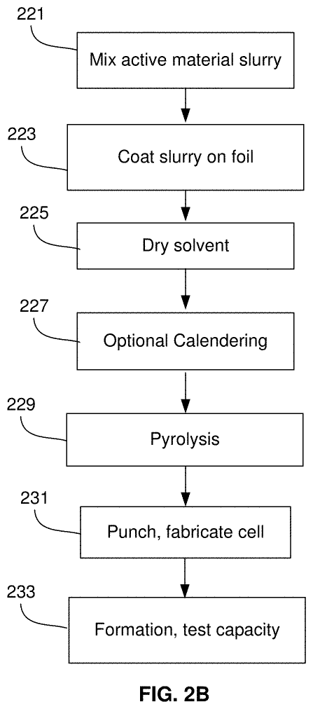

FIG. 2A is a flow diagram of a lamination process for forming a silicon-dominant anode cell, in accordance with an example embodiment of the disclosure. This process employs a high-temperature pyrolysis process on a substrate, layer removal, and a lamination process to adhere the active material layer to a current collector.

The raw electrode active material is mixed in step 201. In the mixing process, the active material may be mixed, e.g., a binder/resin (such as PI, PAI), solvent, and conductive additives. The materials may comprise carbon nanotubes/fibers, graphene sheets, metal polymers, metals, semiconductors, and/or metal oxides, for example. Silicon powder with a 1-30 or 5-30 μm particle size, for example, may then be dispersed in polyamic acid resin (15% solids in N-Methyl pyrrolidone (NMP)) at, e.g., 1000 rpm for, e.g., 10 minutes, and then the conjugated carbon/NMP slurry may be added and dispersed at, e.g., 2000 rpm for, e.g., 10 minutes to achieve a slurry viscosity within 2000-4000 cP and a total solid content of about 30%.

In step 203, the slurry may be coated on a substrate. In this step, the slurry may be coated onto a Polyester, polyethylene terephthalate (PET), or Mylar film at a loading of, e.g., 2-4 mg/cm² and then in step 205 undergo drying to an anode coupon with high Si content and less than 15% residual solvent content. This may be followed by an optional calendering process in step 207, where a series of hard pressure rollers may be used to finish the film/substrate into a smoothed and denser sheet of material.

In step 209, the green film may then be removed from the PET, where the active material may be peeled off the polymer substrate, the peeling process being optional for a polypropylene (PP) substrate, since PP can leave ˜2% char residue upon pyrolysis. The peeling may be followed by a pyrolysis step 211 where the material may be heated to >900 C but less than 1250 C for 1-3 hours, cut into sheets, and vacuum dried using a two-stage process (120° C. for 15 h, 220° C. for 5 h). The dry film may be thermally treated at, e.g., 1100-1200° C. to convert the polymer matrix into carbon.

In step 213, the electrode material may be laminated on a current collector. For example, a 5-20 μm thick copper foil may be coated with polyamide-imide with a nominal loading of, e.g., 0.2-0.6 mg/cm² (applied as a 6 wt % varnish in NMP and dried for, e.g., 12-18 hours at, e.g., 110° C. under vacuum). The anode coupon may then be laminated on this adhesive-coated current collector. In an example scenario, the silicon-carbon composite film is laminated to the coated copper using a heated hydraulic press. An example lamination press process comprises 30-70 seconds at 300° C. and 3000-5000 psi, thereby forming the finished silicon-composite electrode.

In instances where the current collector foil is not pre-punched/pre-perforated, the formed electrode may be perforated with a punching roller, for example. The punched electrodes may then be sandwiched with a separator and electrolyte to form a cell.

In an example scenario, the electrolyte 513 may comprise Lithium hexafluorophosphate (LiPF₆) and lithium bis(trifluoromethanesulfonyl)imide (LiTFSI) that may be used together in a variety of electrolyte solvents. Lithium hexafluorophosphate (LiPF₆) may be present at a concentration of about 0.2 to 2.0 molar (M) and lithium bis(trifluoromethanesulfonyl)imide (LiTFSI) may be present at a concentration of about 0.1 to 2.0 molar (M). Solvents may comprise one or more of ethylene carbonate (EC), fluoroethylene carbonate (FEC) and/or ethyl methyl carbonate (EMC) in various percentages. In some embodiments, the electrolyte solvents may comprise one or more of EC from about 0-40%, FEC from about 2-40% and/or EMC from about 50-70%. In another example, the electrolyte comprises 20% or more FEC. In another example, the electrolyte may comprise no cyclic carbonate other than FEC.

FIG. 2B is a flow diagram of a direct coating process for forming a silicon-dominant anode cell, in accordance with an example embodiment of the disclosure. This process comprises physically mixing the active material, conductive additive, and binder together, and coating it directly on a current collector. This example process comprises a direct coating process in which an anode or cathode slurry is directly coated on a copper foil using a binder such as CMC, SBR, Sodium Alginate, PAI, PI and mixtures and combinations thereof.

In step 221, the active material may be mixed, e.g., a binder/resin (such as PI, PAI), solvent, and conductive additives. The materials may comprise carbon nanotubes/fibers, graphene sheets, metal polymers, metals, semiconductors, and/or metal oxides, for example. Silicon powder with a 1-30 or 5-30 μm particle size, for example, may then be dispersed in polyamic acid resin (15% solids in N-Methyl pyrrolidone (NMP)) at, e.g., 1000 rpm for, e.g., 10 minutes, and then the conjugated carbon/NMP slurry may be added and dispersed at, e.g., 2000 rpm for, e.g., 10 minutes to achieve a slurry viscosity within 2000-4000 cP and a total solid content of about 30%.

Furthermore, cathode active materials may be mixed in step 221, where the active material may comprise lithium cobalt oxide (LCO), lithium iron phosphate, lithium nickel cobalt manganese oxide (NMC), lithium nickel cobalt aluminum oxide (NCA), lithium manganese oxide (LMO), lithium nickel manganese spinel, or similar materials or combinations thereof, mixed with a binder as described above for the anode active material.

In step 223, the slurry may be coated on a copper foil. In the direct coating process described here, an anode slurry is coated on a current collector with residual solvent followed by a calendaring process for densification followed by pyrolysis (˜500-800 C) such that carbon precursors are partially or completely converted into glassy carbon. Similarly, cathode active materials may be coated on a foil material, such as aluminum, for example. The active material layer may undergo a drying in step 225 resulting in reduced residual solvent content. An optional calendering process may be utilized in step 227 where a series of hard pressure rollers may be used to finish the film/substrate into a smoother and denser sheet of material. In step 227, the foil and coating proceeds through a roll press for lamination.

In step 229, the active material may be pyrolyzed by heating to 500-1000° C. such that carbon precursors are partially or completely converted into glassy carbon.

Pyrolysis can be done either in roll form or after punching. If done in roll form, the punching is done after the pyrolysis process. The pyrolysis step may result in an anode active material having silicon content greater than or equal to 50% by weight, where the anode has been subjected to heating at or above 400 degrees Celsius. In instances where the current collector foil is not pre-punched/pre-perforated, the formed electrode may be perforated with a punching roller, for example. The punched electrodes may then be sandwiched with a separator and electrolyte to form a cell.

In an example scenario, the electrolyte may comprise Lithium hexafluorophosphate (LiPF₆) and lithium bis(trifluoromethanesulfonyl)imide (LiTFSI) that may be used together in a variety of electrolyte solvents. Lithium hexafluorophosphate (LiPF₆) may be present at a concentration of about 0.2 to 2.0 molar (M) and lithium bis(trifluoromethanesulfonyl)imide (LiTFSI) may be present at a concentration of about 0 to 2.0 molar (M). Solvents may comprise one or more of ethylene carbonate (EC), fluoroethylene carbonate (FEC) and/or ethyl methyl carbonate (EMC) in various percentages. In some embodiments, the electrolyte solvents may comprise one or more of EC from about 0-40%, FEC from about 2-40% and/or EMC from about 50-70%. In another example, the electrolyte comprises 20% or more FEC. In another example, the electrolyte may comprise no cyclic carbonate other than FEC.

In step 233, the cell may be subjected to a formation process, comprising initial charge and discharge steps to lithiate the anode, with some residual lithium remaining, and the cell capacity may be assessed. The formation process and any cycling tests may create an SEI layer at the anode active material layer and electrolyte interface, which may improve cell safety. Furthermore, the thermal conductivity of the silicon-dominant anode active material layer may mitigate thermal runaway issues.

In another example scenario, the anode active material layer may comprise 20 to 95% silicon and in yet another example scenario may comprise 50 to 95% silicon by weight.

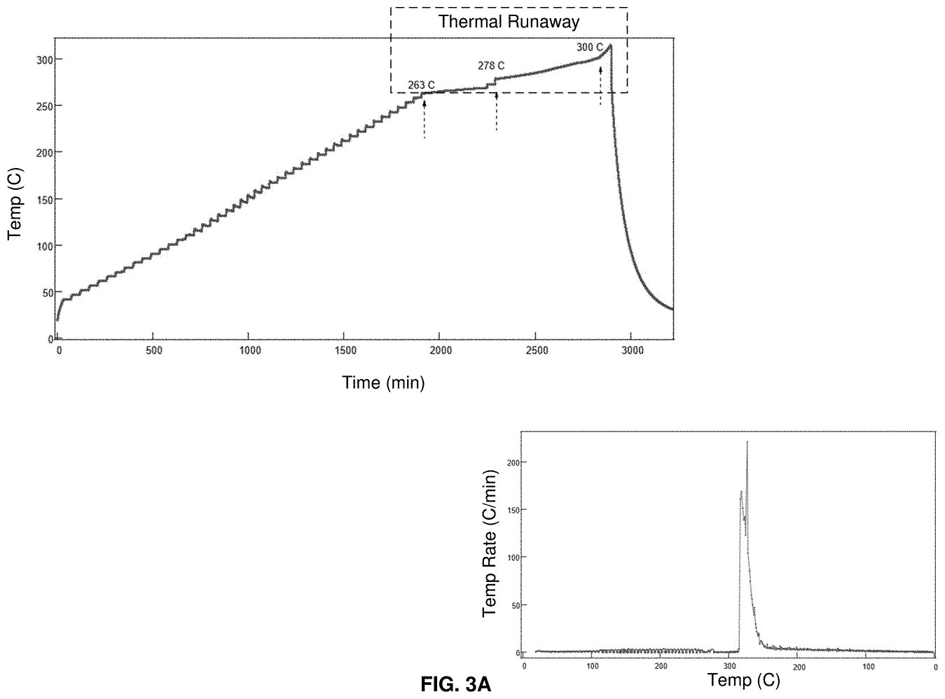

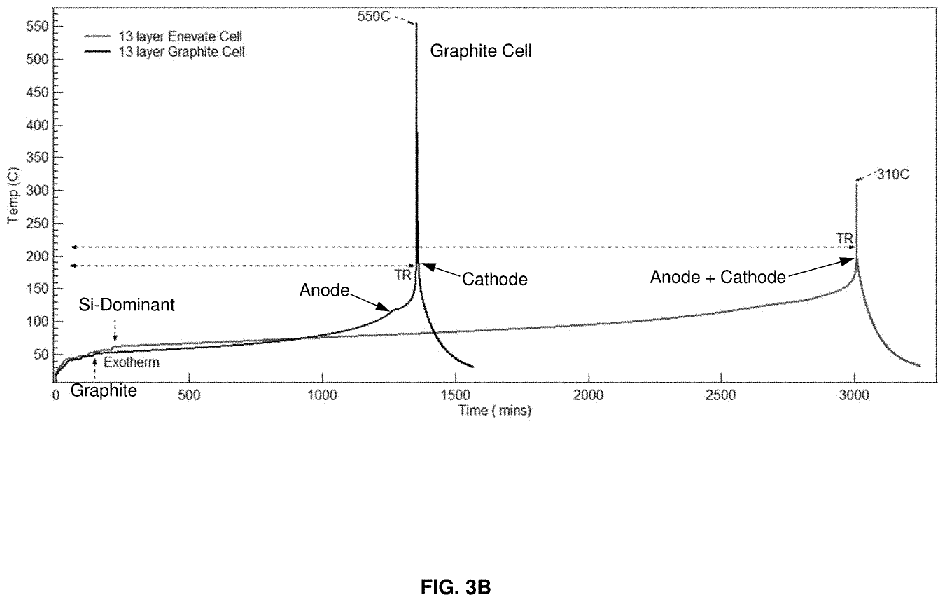

FIG. 3A illustrates accelerating rate calorimeter results for a silicon-dominant anode cell, in accordance with an example embodiment of the disclosure. Referring to FIG. 3A, there is shown temperature versus time for a cell in an accelerating rate calorimeter (ARC) test, where exothermic runaway reactions are simulated through adaptive adiabatic control in a controlled environment. The ARC test system tries to match the cell temperature, so as the cell heats up, so does the calorimeter temperature. In an example scenario, a “heat-wait-seek” protocol may be utilized, where small heat steps are applied and after a wait period for isothermal equilibrium, there is a seek period to detect heat release in the cell by temperature rise. When the cell begins to heat above that of the step temperature, an exothermic mode is indicated, and the system tracks the resulting increasing temperature.

An ARC test temperature profile is shown in FIG. 3A, where the cell comprise a silicon-dominant anode cell with bonded anode and five NCM cathode layers, charged to 100% SOC. The cell is 4 C charged to 4.2V, held constant voltage until C/20. In the test, discrete 5° C. temperature steps are made with a half hour wait period for stabilization, where the threshold sensitivity is 0.02° C./min. This continues up to 263° C., where thermal runaway begins. Two more temperature steps are shown before the cell reaches 300° C. through exothermic runaway and the ARC test is halted. The thermal runaway starting temperature of 263° C. is much higher than conventional graphite cells and graphite cells with silicon additives, where thermal runaway starts in the 130-180° C. range. This shows the greatly enhanced safety of the silicon-dominant anodes described here. Increase thermal conductivity of anode active material may enable the greatly increased thermal runaway temperatures obtained with silicon-dominant anode cells.

In the ARC test of FIG. 3A, at 263° C., the cell self-heating rate surpassed the threshold of 0.02 C/min, and the system went into exotherm mode. The self-heating rate dropped below threshold and the system went through additional heat steps to 278° C. At 278° C., the cell passed the heating threshold again and went into exotherm. The cell heating rate rose significantly at 278-300° C. and the cell temperature continued to rise until reaching 315° C. (max for the cell), and the ARC system stopped heating the cell and cooled. In this example, the cell was thin, so dissipated heat quickly and the initial thermal runaway reaction did not cause the cell's external surface to reach 315° C., causing the ARC to keep heating.

The inset to the lower right shows the temperature rate in ° C./min versus time, showing a low rate of temperature change with small blips corresponding to ARC test temperature steps, until the large temperature change at thermal runaway. The silicon-dominant cells disclosed here may have a thermal runaway temperature that ranges from at least 200° C., or ranging from 200−220° C., 230-240° C., 250-260° C., 250-270° C. or 255-265° C.

FIG. 3B illustrates another accelerating rate calorimeter result for a silicon-dominant anode cell and a graphite cell, in accordance with an example embodiment of the disclosure. Referring to FIG. 3B, there is shown ARC test curves for a graphite cell and a silicon-dominant anode cell. The silicon-dominant anode cell comprised a direct-coated anode and both cells had NCM811 cathode with 13 layers in each cell. The SOC for the test was 100%, charged to 4.2V and held constant until C/20. As above, the ARC test comprised 5° C. steps with a half hour wait period, and a threshold sensitivity of 0.02 C/min.

The exothermal reactions in a cell occur in steps, where SEI decomposition is the first sign of exothermal reaction. For the graphite cell, the SEI decomposition starts at 52° C., where it passes the heating threshold and goes into thermal runaway starting at 185° C., while the silicon-dominant cell SEI reaction starts at 63° C. After the SEI reaction starts, the separator starts heating up and melting. In these systems, this phase is shown by the long flat line regions of the plots where the temperature slowly ramp up. The SEI reaction for these cells may be fall within a range or 60+/−5° C.

Next is anode propagation, also referred to as anode runaway. In graphite cells, the graphite reaction normally occurs around 120° C., in this case a clear reaction at 117° C. indicated by the shoulder in the graphite cell curve that is labeled “Anode”. This causes the thermal runaway to happen earlier for graphite cells. The graphite cell heating rate rose quickly to reach the peak temp, and the cell temperature continued to self-burn until reaching 556° C.

For silicon-dominant anode cells, no such separate anode signal is observed, meaning the anode reaction occurs around the same temperature as the cathode propagation, labeled as “Anode+Cathode” in FIG. 3B. The cathode reaction follows for the graphite cell, which occurs at around 180-200° C., which leads to thermal runaway, and the electrolyte decomposes.

For the silicon-dominant anode cell, at 63° C., the cell self-heating rate surpassed threshold of 0.02° C./min, and system went into exotherm mode. Cell heating rate slowly increased for a long period of time and finally rose significantly starting at 210° C. and had a peak at 310° C. This self-heating rate threshold temperature may vary in a range of 60+/−5° C. for the cells disclosed here.

The silicon-dominant anode cell started exotherm mode and thermal runaway at a higher temperature than the graphite cell, which also burned hotter than the silicon cell. The peak of thermal runaway is 200° C. higher in the graphite cell and it takes longer for the silicon cell to reach thermal runaway.

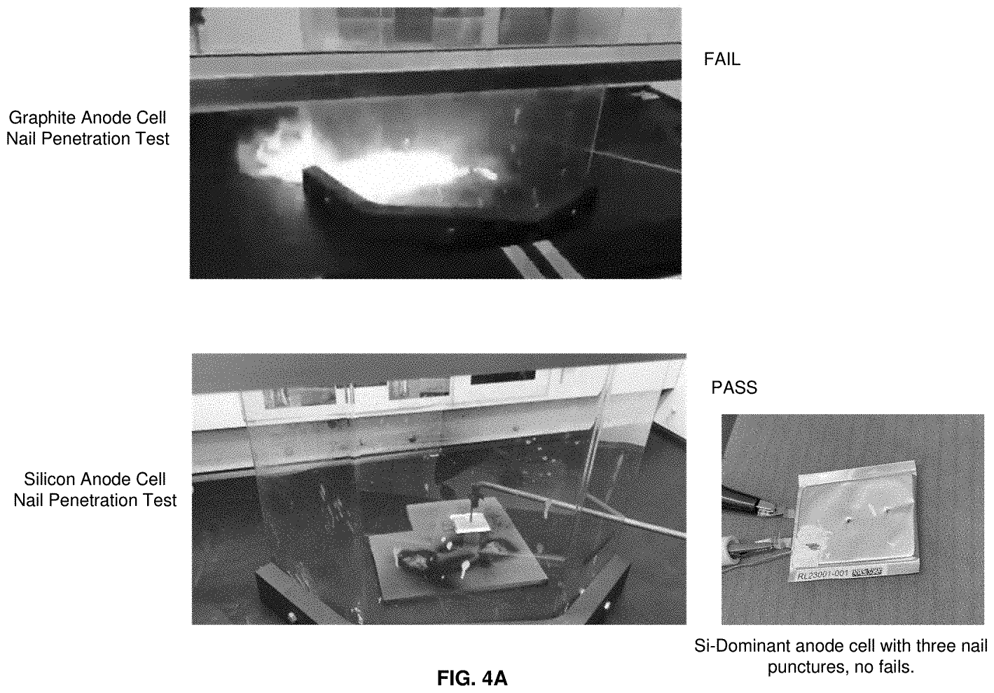

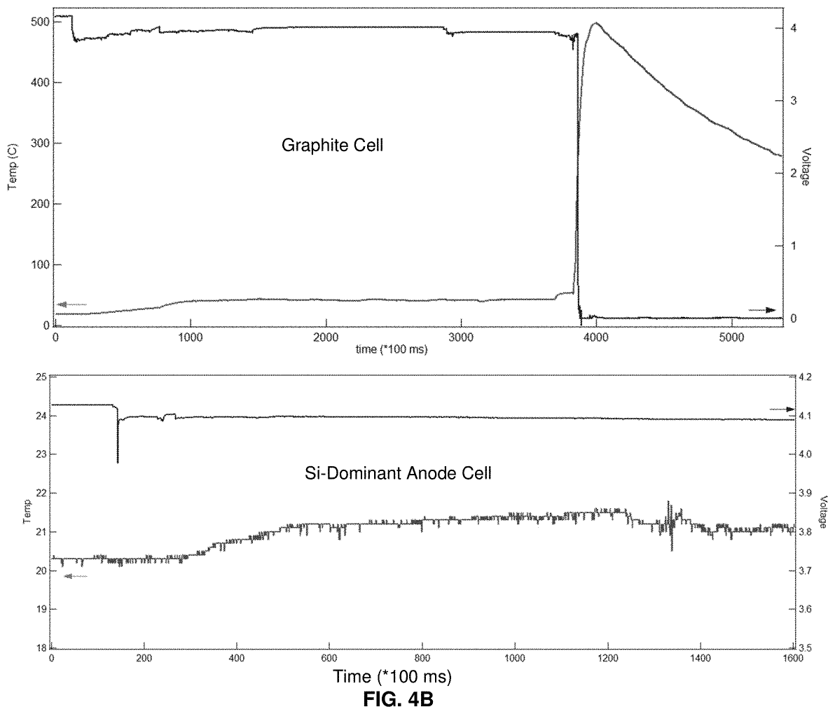

FIG. 4A illustrates nail penetration tests for a graphite cell and a silicon-dominant anode cell, in accordance with an example embodiment of the disclosure. Referring to FIG. 4A, there is shown a nail penetration test on a graphite cell on top and a silicon-dominant anode cell on bottom. The nail penetration test is simply the creation of a short circuit by forcing a nail through the cell and observing the results.

Example variables in the nail penetration test cells are silicon vs graphite, type of separator, and higher/lower (4.2 V vs 4.1 V) cell voltage. The separators are both polyolefin separators, but one type has ceramic coating on both sides to prevent shrinkage of the separator and the other has a layer of polymer, such as PVDF and/or PMMA, for example, on both sides of the separator, but no ceramic coating.

In one example, each cell comprises a silicon-dominant or graphite anode, an NCM cathode, ceramic-coated separator. Cells were charged to 4.2V with C/20 taper (fully charged) before the nail penetration tests, and two cells per type were tested. The nail used was 3.25 mm in diameter and comprised mild steel. The silicon-dominant anode cells did not have thermal runaway during the tests, while both graphite anode based cells did have thermal runaway during the tests.

In a second example, each cell comprises a silicon-dominant or graphite anode, an NCM cathode, and polymer-coated separator. Cells were charged to 4.1V with C/20 taper (fully charged) before the nail penetration tests, and two cells per type were tested. The silicon-dominant anode cells did not have thermal runaway during the tests, while both graphite anode based cells have thermal runaway during the tests.

Therefore, graphite cells with polymer-coated polyolefin separators failed the nail penetration test at both voltages, as shown by the graphite cell test in FIG. 4, and only passed at lower voltage with ceramic-coated separators. In contrast, the silicon-dominant anode cells passed at both voltages with ceramic coated separators and passed with polymer-coated polyolefin separators at 4.1 V. This further illustrates the significantly improved safety of the silicon-dominant anode cells described here.

FIG. 4B illustrates voltage and temperature curves for a silicon-dominant anode cell and a graphite cell during a nail penetration test, in accordance with an example embodiment of the disclosure. The puncturing of the cell occurs at the step in voltage on the left side of the plots. Referring to FIG. 4B, the graphite cell shows a sudden rise in temperature to ˜500° C. with a corresponding drop in voltage to zero, while the silicon-dominant anode cell remains nearly constant temperature varying about 1° C. with only a small step in voltage at the time of puncture but otherwise remaining constant, further illustrating the significantly improved safety of silicon-dominant anode cells.

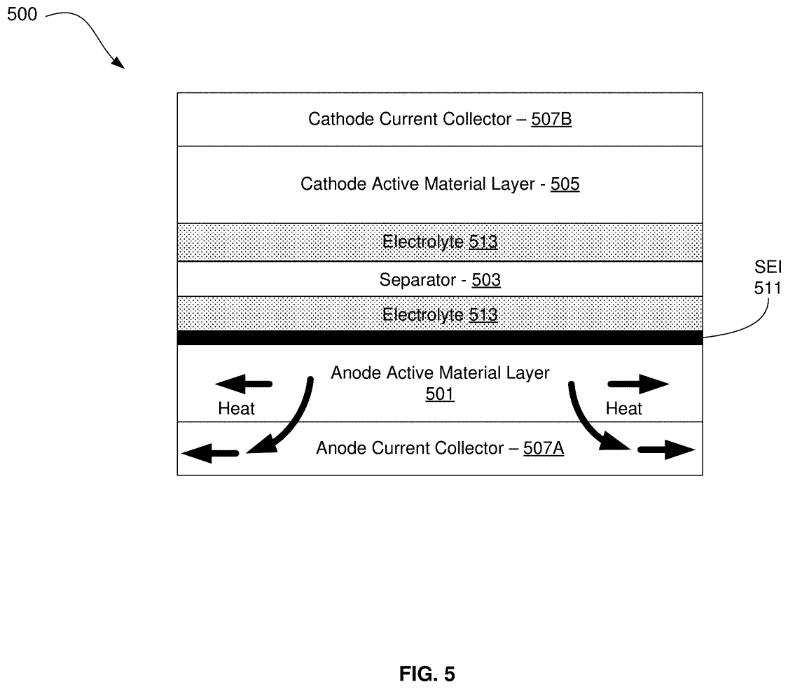

FIG. 5 illustrates a silicon-dominant anode lithium ion cell, in accordance with an example embodiment of the disclosure. Referring to FIG. 5, there is shown cell 500 comprising an anode active material layer 501, a separator 503, cathode active material layer 505, anode and cathode current collectors 507A and 507B, and SEI 511. The active materials 501 and 505, current collectors 507A and 507B, separator 503, and electrolyte 513 may be as described previously. In an example scenario, the electrolyte 513 may comprise Lithium hexafluorophosphate (LiPF₆) and lithium bis(trifluoromethanesulfonyl)imide (LiTFSI) that may be used together in a variety of electrolyte solvents. Lithium hexafluorophosphate (LiPF₆) may be present at a concentration of about 0.2 to 2.0 molar (M) and lithium bis(trifluoromethanesulfonyl)imide (LiTFSI) may be present at a concentration of about 0 to 2.0 molar (M). Solvents may comprise one or more of ethylene carbonate (EC), fluoroethylene carbonate (FEC) and/or ethyl methyl carbonate (EMC) in various percentages. In some embodiments, the electrolyte solvents may comprise one or more of EC from about 0-40%, FEC from about 2-40% and/or EMC from about 50-70%. In another example, the electrolyte comprises 20% or more FEC. In another example, the electrolyte may comprise no cyclic carbonate other than FEC.

The SEI 511 comprises an interface layer between the anode active material layer 501 and the electrolyte 513 formed by reactions between these two layers. While the SEI 511 can reduce cell performance somewhat due to increased impedance, it can also provide enhanced safety. One mechanism by which the SEI 511 may improve cell safety is through increased thermal conductivity of the layer, mitigating heat build-up that can lead to thermal runaway. In addition, the SEI 511 may provide a protective layer from exothermic reactions, where the SEI comprises materials such as LiF or other inorganic compounds, a more stable salt, such as LiTFSI, which may mitigate reactions between LiPF₆ and electrode surfaces. These adverse reactions can destabilize the carbonate solvents (such as FEC), ultimately decomposing them, and which are also often flammable. In addition, any other processes that allow the electrodes to come into contact with and/or form lithium metal (as opposed to ions) and/or generate oxygen, can cause a thermal runaway reaction, which is mitigated with the more stable SEI disclosed here.

In an example embodiment of the disclosure, a method and system is described for safety of silicon dominant anodes in a battery. The battery may include an anode comprising an anode active material layer on a metal current collector, where the anode active material layer comprises pyrolyzed binder, conductive additives, and 50% or more silicon by weight; a separator; an electrolyte; a cathode; and a solid electrolyte interface between the anode active material layer and the electrolyte, where the battery has a thermal runaway temperature of greater than 200° C. The conductive additives may comprise between 1% and 40% of the active material layer. The anode active material layer may comprise between 20% to 95% silicon. The separator may comprise ceramic-coated polyolefin or polymer-coated polyolefin. The electrolyte may comprise Lithium hexafluorophosphate (LiPF₆) and/or lithium bis(trifluoromethanesulfonyl)imide (LiTFSI) in one or more electrolyte solvents. The metal current collector may comprise copper.

The electrolyte may comprise 20% or more FEC. Upon heating, the anode does not go into thermal runaway before the cathode. Upon heating, the solid electrolyte interface may not begin to decompose until 60+/−5° C. The battery does not go into thermal runaway when punctured by a nail and a temperature of the battery when punctured by a nail does not rise by more than 2° C. The battery has a thermal runaway temperature of greater than 260° C.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, a battery, circuitry or a device is “operable” to perform a function whenever the battery, circuitry or device comprises the necessary hardware and code (if any is necessary) or other elements to perform the function, regardless of whether performance of the function is disabled or not enabled (e.g., by a user-configurable setting, factory trim, configuration, etc.).

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A battery comprising:
an anode comprising an anode active material layer on a metal current collector, the anode active material layer comprising pyrolyzed binder, conductive additives, and 50% or more silicon by weight;
a separator;
an electrolyte;
a cathode; and
a solid electrolyte interface between the anode active material layer and the electrolyte;
wherein a composition of one or both of the anode and the electrolyte and/or a formation process of the battery are configured such that the battery has a thermal runaway temperature of greater than 200° C.

2. The battery according to claim 1, wherein the conductive additives comprise between 1% and 40% of the active material layer by weight.

3. The battery according to claim 1, wherein the anode active material layer comprises between 20% to 95% silicon by weight.

4. The battery according to claim 1, wherein the separator comprises ceramic-coated polyolefin.

5. (canceled)

6. The battery according to claim 1, wherein the electrolyte comprises 20% or more FEC by weight.

7. The battery according to claim 1, wherein upon heating, the anode does not go into thermal runaway before the cathode.

8. (canceled)

9. The battery according to claim 1, wherein the battery does not go into thermal runaway when punctured by a nail.

10. The battery according to claim 1, wherein a temperature of the battery when punctured by a nail does not rise by more than 2° C.

11. The battery according to claim 1, wherein the battery has a thermal runaway temperature of greater than 260° C.

12. A method for battery safety, the method comprising providing a battery comprising an anode comprising an anode active material layer on a metal current collector, the anode active material layer comprising pyrolyzed binder, conductive additives, and 50% or more silicon by weight;
a separator;
an electrolyte;
a cathode; and
a solid electrolyte interface between the anode active material layer and the electrolyte;
wherein a composition of one or both of the anode and the electrolyte and/or a formation process of the battery are configured such that the battery has a thermal runaway temperature of greater than 200° C.

13. The method according to claim 12, wherein the conductive additives comprise between 1% and 40% of the active material layer by weight.

14. The method according to claim 12, wherein the anode active material layer comprises between 20% to 95% silicon by weight.

15. The method according to claim 12, wherein the separator comprises ceramic-coated polyolefin.

16. (canceled)

17. The method according to claim 12, wherein the electrolyte comprises 20% or more FEC by weight.

18. (canceled)

19. The method according to claim 12, wherein upon heating, the anode does not go into thermal runaway before the cathode.

20. The method according to claim 12, wherein the battery does not go into thermal runaway when punctured by a nail.

21. The method according to claim 12, wherein a temperature of the battery when punctured by a nail does not rise by more than 2° C.

22. The method according to claim 12, wherein the battery has a thermal runaway temperature of greater than 260° C.

23. (canceled)

24. The battery according to claim 1, wherein:
wherein the electrolyte comprises lithium bis(trifluoromethanesulfonyl)imide (LiTFSI) in one or more electrolyte solvents; and
the LiTFSI is present at concentration of about 0 to 2.0 molar (M).

25. The method according to claim 12, wherein:
wherein the electrolyte comprises lithium bis(trifluoromethanesulfonyl)imide (LiTFSI) in one or more electrolyte solvents; and
providing the LiTFSI such that when present the LiTFSI is at concentration of about 0 to 2.0 molar (M).

26. The battery according to claim 1, wherein upon heating, the solid electrolyte interface does not begin to decompose until 60+/−5° C.

27. The method according to claim 12, wherein upon heating, the solid electrolyte interface does not begin to decompose until 60+/−5° C.
